(19) United States
(12) Patent Application Publication
(10) Pub. No.: US 2026/0339440 A1
(43) Pub. Date: Oct. 29, 2026

(54) WEARABLE THEATER COMMUNICATIONS SYSTEM

(71) Applicants: Alexander Julian Stumpf, Austin, TX (US); Katerina Julianne Stumpf, Austin, TX (US)

(72) Inventors: Alexander Julian Stumpf, Austin, TX (US); Katerina Julianne Stumpf, Austin, TX (US)

(21) Appl. No.: 19/671,012

(22) Filed: May 7, 2026

Related U.S. Application Data
(63) Continuation-in-part of application No. 19/285,036, filed on Jul. 30, 2025.
(60) Provisional application No. 63/677,773, filed on Jul. 31, 2024.

(51) Int. Cl. G06F 3/01

(52) U.S. Cl. CPC G06F 3/016; G06F 3/011

(57) ABSTRACT

Devices and methods for processing cues during a theater performance are disclosed. A wearable device including a screen, a haptic motor, and wired and wireless communication interfaces is associated with a category of tasks related to the performance and alerts a user about cues belonging to the category of tasks that the device is associated with. The device receives a first cue and an associated first identifier associated with a first task. The device determines whether the first cue belongs to the first category of tasks and, in response to determining that the first cue belongs to the first category of tasks, alerts the user about the first cue by displaying the first cue, the first identifier, or a text string associated with the first cue on the screen and generating, from the haptic motor, a first vibration signal associated with the first cue.

### CROSS-REFERENCE TO RELATED APPLICATIONS

This application claims priority to U.S. Provisional Patent Application No. 63/677,773 filed Jul. 31, 2024, entitled “Wearable Tech Theater Communications System,” and U.S. patent application Ser. No. 19/285,036 filed Jul. 30, 2025, entitled “Wearable Theater Communications System”, of which this application is a Continuation-in-Part, and both of which are hereby incorporated by reference in their entirety.

### BACKGROUND

Theater communication systems are designed to facilitate stage supervision, monitoring, coordination, and scheduling. They enable seamless audio and video interaction between stage managers, directors, sound engineers, lighting technicians, and performers, ensuring that critical instructions are delivered instantly. When an issue arises during a performance, crew members can quickly contact the stage manager for guidance, providing a smooth production. Theater communication systems can include a variety of components such as stage crew headsets, belt packs, and base stations.

A theatrical cue is a trigger for an action to be carried out at a specific time. It is generally associated with the theater and film industry. Cues can be necessary to implement a lighting change or effect, a sound effect, or some sort of stage or set movement/change during a theatrical-type production. Cues are generally given by a stage manager to crew members working backstage to operate various systems associated with the production. Generally, cues can be of three types: Warning, Standby, or Go. A Warning cue is given about a minute prior to the cue and gives time for crew members to get ready and make sure everything is set (this is especially important with cues for set or rail changes). A Standby cue is given a few seconds before the cue and tells the crew members everything should be set and they should be standing by to go. A Go cue is given at the moment the cue should be executed, which sets the crew members into action.

LoRa (abbreviation of “long range,” also sometimes abbreviated as “LR”) is a physical proprietary radio communication technique that is based on spread spectrum modulation techniques derived from chirp spread spectrum (CSS) technology. LoRa uses license-free sub-gigahertz radio frequency bands EU433 (LPD433) or EU868 (863-870/873 MHz) in Europe, AU915/AS923-1 (915-928 MHz) in South America, US915 (902-928 MHz) in North America, IN865 (865-867 MHz) in India, and AS923 (915-928 MHz) in other parts of Asia. LoRa enables long-range transmissions with low power consumption. The technology covers the physical communication layer, while other technologies and protocols, such as LoRa wide area network (LoRaWAN), cover higher communication layers. LoRaWAN defines the communication protocol and system architecture. LoRaWAN is an official standard of the International Telecommunication Union (ITU), ITU-T Y.4480. Together, LoRa and LoRaWAN define a low-power, wide-area (LPWA) networking protocol designed to wirelessly connect battery-operated devices to the Internet in regional, national, or global networks and target key Internet of Things (IoT) requirements, such as bidirectional communication, end-to-end security, and mobility and localization services. The low power, low bit rate, and IoT use distinguish this type of network from a wireless WAN that is designed to connect users or businesses and carry more data using more power. The LoRaWAN data rate ranges from 0.3 kbit/s to 50 kbit/s per channel.

### BRIEF DESCRIPTION OF THE DRAWINGS

Detailed descriptions of implementations of the present invention will be described and explained through the use of the accompanying drawings.

FIG. 1A shows an example embodiment of a wearable device with aspects of the disclosed technology implemented that is configured for use during a theater performance.

FIG. 1B shows an example embodiment of a wearable device with aspects of the disclosed technology implemented that is configured for use during a pre-show phase of theater performance.

FIG. 2 shows an example embodiment of a wearable device in which aspects of the disclosed technology are implemented.

FIG. 3 shows various components of a wearable device in which aspects of the disclosed technology are implemented.

FIG. 4A shows examples of information presented on a screen of a wearable receiver device in which aspects of the disclosed technology are implemented.

FIG. 4B shows an expanded view of examples of information presented on a screen of a wearable receiver device in which aspects of the disclosed technology are implemented.

FIG. 5 shows another example embodiment of a device in which aspects of the disclosed technology are implemented.

FIG. 6A shows an example embodiment of a transmitter device in which aspects of the disclosed technology are implemented.

FIGS. 6B-6D show various components of a transmitter device in which aspects of the disclosed technology are implemented.

FIG. 7A shows a front view of an example embodiment of a transmitter device in which aspects of the disclosed technology are implemented.

FIG. 7B shows a back view of an example embodiment of a transmitter device in which aspects of the disclosed technology are implemented.

FIGS. 8A-8D show various components of an example embodiment of a wearable device in which aspects of the disclosed technology are implemented.

FIGS. 9A and 9B show various components of an example embodiment of a transmitter device in which aspects of the disclosed technology are implemented.

FIG. 10A shows a flowchart of an example method in which aspects of the disclosed technology are implemented.

FIG. 10B shows a flowchart of an example method in which aspects of the disclosed technology are implemented.

FIG. 11 is a block diagram that illustrates an example of a computer system in which at least some operations described herein can be implemented.

FIG. 12A shows an example of an inductive charging coil that can be included in some embodiments of the disclosed technology.

FIG. 12B shows an example of an ultra-wideband (UWB) radio that can be included in some embodiments of the disclosed technology.

FIG. 13A shows an example of a formation diagram of stage performers associated with a theater performance.

FIG. 13B shows a plan view of an example implementation of location anchors in which aspects of the disclosed technology are implemented.

FIGS. 14A-14F show additional example embodiments of wearable receiver devices in which aspects of the disclosed technology are implemented.

FIGS. 15A and 15B show example implementations of the disclosed technology for location tracking of stage performers during a theater performance.

FIG. 16 shows an example implementation of the disclosed technology for geofencing an area in a theater during a theater performance.

FIG. 17 shows a flowchart of a process in which aspects of the disclosed technology are implemented.

FIG. 18 shows a flowchart of a process in which aspects of the disclosed technology are implemented.

FIG. 19A shows an example of a video captured by a device in which aspects of the disclosed technology are implemented.

FIG. 19B shows an example of a body of interest isolated from a video captured by a device in which aspects of the disclosed technology are implemented.

FIG. 19C shows an example of a pose of a body of interest extracted from a video captured by a device in which aspects of the disclosed technology are implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to systems, methods, and devices for managing backstage communication among crewmembers of a theatrical-type production. In some embodiments, the disclosed technology includes a transmitter device that can send cues to one or more receiver devices. In some embodiments, a receiver device can be a wearable receiver device—for example, one that can be worn on a human wrist like a wristwatch. In some embodiments, the wearable receiver device can include a screen for displaying a cue received from the transmitter device. In some embodiments, the wearable receiver device can include a haptic motor for alerting a user to the cue by generating a recognizable vibration signal from the haptic motor. In some embodiments, the wearable receiver device can be a screenless device that can discreetly alert the user, for example, an actor on the stage, by generating a recognizable vibration signal from a haptic motor included in the wearable receiver device. In some embodiments, the receiver device can be a tablet-like device with a large screen that can display detailed or multimedia-rich cues. In some embodiments, the receiver device can be configured to persistently display a received cue on a screen of the receiver device until the next cue is received. In some embodiments, the receiver device can include an ultraviolet (UV) light source that can be used to illuminate UV-sensitive markings in low-light conditions. In some embodiments, the receiver device can include a motion sensor, such as, for example, an accelerometer, to reduce energy consumption of the receiver device by only activating the screen when the motion sensor detects motion, such as, for example, raising of the user's wrist.

In some embodiments, the transmitter device can store one or more cues to be sent to the receiver devices. In some embodiments, the one or more cues can be stored in the transmitter device in advance of an upcoming theatrical production. In some embodiments, the transmitter device can include one or more wired or wireless communication interfaces, such as Ethernet, Wi-Fi, or Bluetooth, respectively, for connecting to a computer. In some embodiments, the transmitter device can receive cues from the computer via any of the communication interfaces. The transmitter device can include a screen for displaying cues. The transmitter device can include input interfaces—for example, buttons for receiving inputs from a user. The user inputs can include, for example, commands associated with navigating through a list of cues displayed on the screen of the transmitter device, selecting a cue, or sending a cue to receiver devices. In some embodiments, the transmitter device can communicate with the one or more receiver devices using LoRaWAN communication protocols.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wearable Theater Communication System

A stage manager of a theater production needs to communicate various instructions or cues in real time to crew members working backstage to manage various events or actions related to the theater performance. There may be a plurality of backstage teams, each managing a different aspect of the performance. For example, different backstage teams may be responsible for managing lights, sounds, curtains, etc. during the performance. Team-specific cues need to be sent to each team at various points during the performance so that crew members of that team can take specific actions designated for them. There is also a need for a pre-show countdown to track various tasks that need to be performed leading up to the start of the performance. Similarly, a mechanism is needed for tracking show timing once the performance begins—for example, time remaining until intermission, etc.

Stage managers commonly use wireless headsets to perform the above tasks; however, the use of wireless headsets poses several challenges. For example, cues issued orally over wireless headsets may be missed or misheard. The missed or misheard cues may not be repeated due to the performance moving on to the next cue. Also, at times, multiple crew members may simultaneously initiate communication and, as a result, may end up talking over each other over the wireless headsets. When wireless headsets are used, transmitting all cues to all team members may also result in excessive communication traffic that is distracting or irrelevant to crew members not associated with those cues. Further, wireless headsets typically used in theater productions may be bulky, expensive, and, as a result of the above-mentioned drawbacks, necessitate crew members to supplement spoken cues by carrying written or printed instructions.

Recognizing the above limitations of current products in the market, the inventor has developed the novel wearable theater communication system disclosed in this patent application. In various embodiments, devices implementing the technology disclosed herein can be discreet, compact, lightweight, or low-cost. In some embodiments, each of a plurality of receiver devices can be assigned to a specific backstage team and configured to only alert the user to cues intended for that backstage team. Thus, presenting distracting or irrelevant information to the user is avoided. In some embodiments, the receiver device can be a wearable device including a screen that can persistently display a received cue on the screen until the next cue is received. Thus, the problem of missed or misheard cues is overcome. In some embodiments, the receiver device can include a haptic motor that can be configured to discreetly alert the user by generating vibration signals.

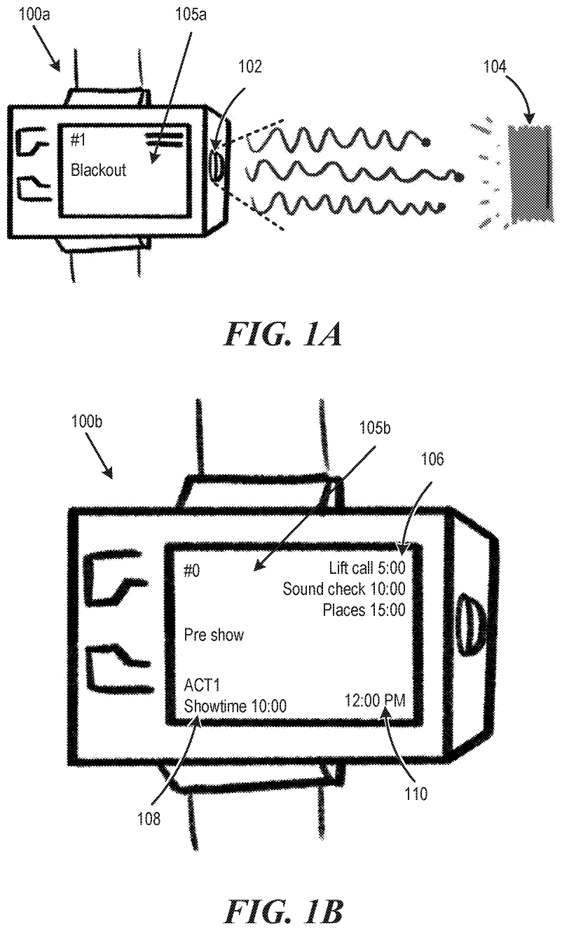

FIG. 1A shows an example embodiment of a wearable receiver device 100a with aspects of the disclosed technology implemented that is configured for use during a theater performance. In some embodiments, the wearable receiver device 100a can include a screen 105a for displaying received cues or other information that may be relevant to a wearer of the wearable receiver device 100a. The wearer of the wearable receiver device can be interchangeably referred to herein as a user of the wearable receiver device. In some embodiments, the received cue can include a cue identifier. The wearable receiver device 100a can be configured to show the cue identifier of the received cue or the text string associated with the received cue. In some embodiments, the received cue can include a text string. In some embodiments, screen 105a can be a color screen that can display multimedia-rich or formatted cues. The wearer of the wearable receiver device 100a can be, for example, a backstage crew member. The wearable receiver device 100a can be assigned to a specific backstage team and can be configured to only alert the wearer to cues that are designated for the backstage team to which the wearable receiver device 100a is assigned. For example, at the beginning of each performance, the wearable receiver device 100a can be assigned to a different team and can be worn by a team member belonging to that team. Thus, multiple identical wearable receiver devices 100a can be interchangeably assigned to different backstage teams at the start of each performance. While the wearable receiver device 100a can receive all cues sent by the transmitter device, once assigned to a particular backstage team, the wearable receiver device 100a can be configured to only alert the wearer to received cues that are designated for that particular backstage team. In some embodiments, the wearable receiver device 100a can be configured or reconfigured by a transmitter device by sending over-the-air configuration commands to the wearable receiver device 100a. In some embodiments, the wearable receiver device 100a can alert the wearer by displaying the received cue on screen 105a. In some embodiments, the wearable receiver device 100a can include a speaker to audibly alert the wearer to a received cue. In some embodiments, the wearable receiver device 100a can include, in addition to or instead of the screen or the speaker, a haptic motor for alerting the wearer to the received cue. In some embodiments, the haptic motor can generate a plurality of vibration patterns, each pattern associated with a different received cue. For example, when an ordinary cue is received, the haptic motor can alert the wearer by vibrating in a first vibration pattern, and when, for example, a cue designated as important is received, the haptic motor can alert the wearer by vibrating in a second vibration pattern. In some embodiments, the wearer can select the vibration pattern to be used by the wearable receiver device 100a to alert the wearer to the received cue.

In some embodiments, the wearable receiver device 100a can include a light source 102. In some embodiments, the light source 102 can be, for example, a blackout ultraviolet (UV) flashlight that is configured to emit UV light. In some embodiments, the wearable receiver device 100a can further include an ambient light sensor that can detect an ambient light level in an area around the wearable receiver device 100a. In some embodiments, when the ambient light sensor detects that the ambient light around the wearable receiver device 100a has reduced below a threshold, the wearable receiver device 100a can enable the light source 102 for operation. In some embodiments, when the wearable receiver device 100a receives a cue, the wearable receiver device 100a can activate the light source 102 so that light emitted by the light source 102 can be used to illuminate reflective markers 104, such as, for example, reflective spikes, placed around the theater. In some embodiments, the light source 102 can be a blackout UV flashlight that is configured to emit UV light that can subtly illuminate UV-reflective markers 104 placed around the theater. In some embodiments, the light source 102 can be configured to emit blue light that can subtly illuminate reflective markers 104 placed around the theater. The light source 102 can be deactivated when not needed—for example, when the wearable receiver device 100a is used in well-lit areas, outdoors, in a film production, etc.

In some embodiments, the wearable receiver device 100a can include a motion sensor or an accelerometer. The motion sensor or accelerometer can be configured to detect motion of the wearer's wrist. The wearable receiver device 100a can be configured to reduce its own energy consumption by only activating the screen 105 or only alerting the user to the received cue on the screen 105 when the motion sensor or accelerometer detects a motion of the wearer's wrist. In some embodiments, the wearable receiver device 100a can further be configured to, once the screen 105 is activated, display the received cue for a threshold period of time and then turn off the screen 105 so as to reduce energy consumption of the wearable receiver device 100a.

In some embodiments, the wearable receiver device 100a can include necessary hardware and software components to determine a current location of the wearable receiver device 100a using signals received from a global positioning system (GPS). In some embodiments, the wearable receiver device 100a can include necessary hardware and software components to determine a current location of the wearable receiver device 100a using ultra-wideband (UWB) technology that is more precise than the current location of the wearable receiver device 100a determined using GPS signals. The wearable receiver device 100a can, in some embodiments, upon determining the wearer's current location and upon further determining that the wearer is not present in a designated location at a designated time, alert the wearer, by displaying a message on the screen 105 or by generating a vibration signal from the haptic motor, that the wearer needs to be in a different location in preparation for an upcoming cue.

FIG. 1B shows an example embodiment of a wearable receiver device 100b with aspects of the disclosed technology implemented that is configured for use during a pre-show phase of theater performance. In some embodiments, the wearable receiver device 100b can include a screen 105b for displaying received cues or other information that may be relevant to a wearer of the wearable receiver device 100b. In some embodiments, in addition to or instead of displaying a received cue, the screen 105b can be configured to show a variety of information such as one or more pre-show countdown timers 106, a show time 108, or a current time 110. The show time 108 indicates the time elapsed from the start of the performance. The one or more pre-show countdown timers 106 can include, for example, time remaining until a show curtain is lifted, a time remaining until a sound check is to be performed, a time remaining until crew members are required to be in their positions, also known as a places call, etc. In some embodiments, when the wearable receiver device 100b receives an intermission-related cue, the wearable receiver device 100b can initiate a configurable intermission countdown timer. In some embodiments, the intermission countdown timer can be configured to be 15 minutes long.

In some embodiments, the wearable receiver device 100b can display, on the screen 105b, technical or operational information related to the wearable receiver device 100b, such as, for example, a battery level indicator, a received signal strength indicator (RSSI), a signal quality indicator, a count of data packets received from the transmitter device, a count of dropped data packets, etc. In some embodiments, the wearable receiver device 100b can be configured to bidirectionally communicate with the transmitter device. The wearable receiver device 100b can, for example, indicate to the transmitter device whether a cue was successfully received or send telemetry data to the transmitter device. The telemetry data can include, for example, signal strength, signal quality, packet loss statistics, received cue statistics, etc. The telemetry data can be used for troubleshooting a communication link between the transmitter device and the wearable receiver device 100b. These are mere examples of bidirectional communication between the wearable receiver device 100b and the transmitter device and are not to be construed as limiting.

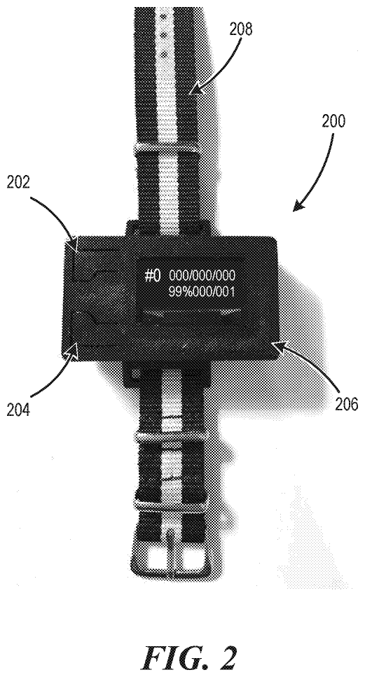

FIG. 2 shows an example embodiment of the wearable receiver device 200 in which aspects of the disclosed technology are implemented. The wearable receiver device 200 can include one or more buttons for the wearer to interact with the wearable receiver device 200. For example, in some embodiments, the wearable receiver device 200 can include an interaction button 202 to make a selection, to navigate through received cues, or to change a configuration setting of the wearable receiver device 200. In some embodiments, the wearable receiver device 200 can include a reset button 204 for resetting the configuration of the wearable receiver device 200. In some embodiments, an external casing of the wearable receiver device 200 can have a dark color, say black, or a nonreflective surface, for example, a matte texture, to further make the wearable receiver device 200 appear discreet in the dark. In some embodiments, the external casing of the wearable receiver device 200 can include a removable lid 206, through which internal components of the wearable receiver device 200 can be accessed, for example, for servicing or troubleshooting problems with the wearable receiver device 200. The wearable receiver device 200 can include a wrist strap 208 for attachment to the wearer's wrist. In some embodiments, the wrist strap 208 may be a standard watch strap having a strap width in the range of 18 millimeters to 22 millimeters. In some embodiments, the external casing of the wearable receiver device 200 or the wrist strap 208 can include suitable colors or textures to allow an actor to discreetly wear the wearable receiver device 200 on stage or to blend the wearable receiver device 200 with the actor's costume.

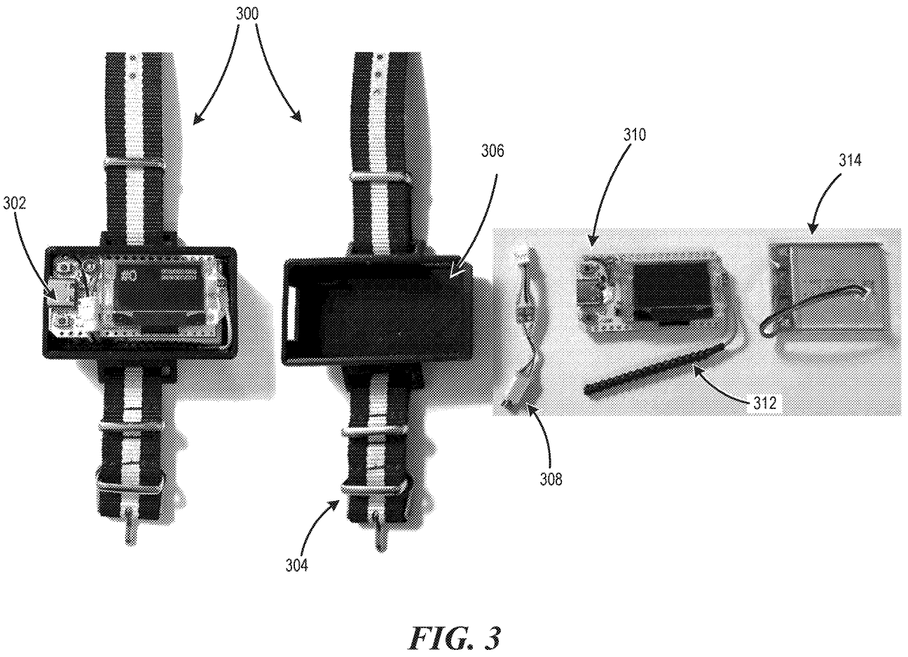

FIG. 3 shows various components of a wearable receiver device 300 in which aspects of the disclosed technology are implemented. The wearable receiver device 300 can include a data transfer and charging port 302 for transferring data to or from the wearable receiver device 300. In some embodiments, the data transfer and charging port 302 can be a universal serial bus (USB) port that is compatible with a USB standard—for example, USB Type A, USB Type C, etc. The wearable receiver device 300 can include a wrist strap 304 for attachment to the wearer's wrist. In some embodiments, the wrist strap 304 may be a standard watch strap having a strap width in the range of 18 millimeters to 22 millimeters. In some embodiments, the wearable receiver device 300 can include a light source 306. In some embodiments, the light source 306 can be, for example, a blackout ultraviolet (UV) flashlight that is configured to emit UV light. In some embodiments, the light source 306 can be remotely controlled by the transmitter device to, for example, emit UV light from the light source 306 upon the wearable receiver device 300 receiving a cue or upon the theater production entering a blackout phase. In some embodiments, the wearable receiver device 300 can include a haptic motor assembly 308 and a component board 310 to which various components, including a display, a LoRaWAN communication module, and an internal LoRaWAN antenna 312, are coupled. In some embodiments, the haptic motor assembly 308 can include a metal oxide semiconductor field effect transistor (MOSFET)-based processor that controls operation of a vibration motor of the haptic motor assembly 308. In some embodiments, the display coupled to the component board 310 can be an organic light-emitting diode (OLED) display. In some embodiments, the component board 310 can be a microcontroller unit (MCU) board. The wearable receiver device 300 can include an energy source 314 for powering operations of the wearable receiver device 300. In some embodiments, the energy source 314 can be a battery, for example, a lithium polymer (LiPo) battery.

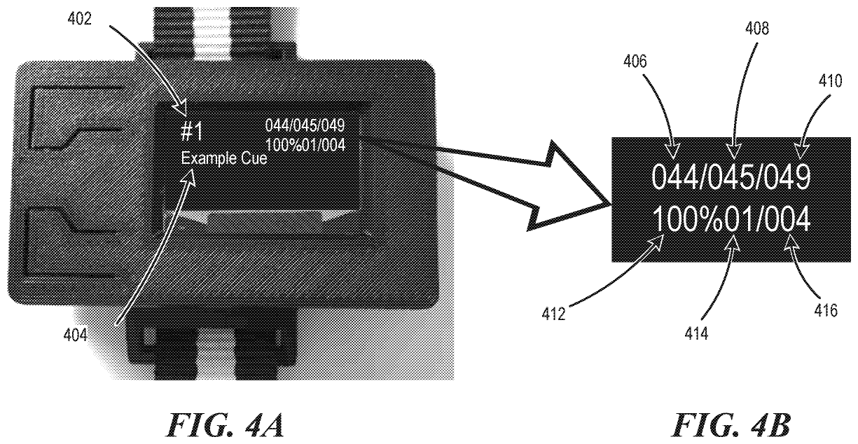

FIG. 4A shows examples of information presented on a screen of a wearable receiver device in which aspects of the disclosed technology are implemented. FIG. 4B shows an expanded view of examples of information presented on a screen of a wearable receiver device in which aspects of the disclosed technology are implemented. In some embodiments, the screen of the wearable receiver device can be configured to display one or more types of information. The one or more types of information can include, for example, a cue identifier 402 of a current cue or a cue text string 404 associated with the current cue. The cue text string 404 can include, for example, a name of the current cue, a description of the current cue, or a description of a task associated with the current cue. The one or more types of information can further include, for example, indicators respectively corresponding to a most recent value 406, an average value 408, or a highest value 410 of RSSI of data packets received by the wearable receiver device from the transmitter device. In some embodiments, the wearable receiver device can display the aforementioned telemetry data on the device's screen. In some embodiments, the wearable receiver device can store the aforementioned telemetry data in the wearable receiver device's computer-readable storage medium and send the data to the transmitter device in response to receiving a command to send the telemetry data. In some embodiments, the wearable receiver device can store the aforementioned telemetry data in the wearable receiver device's computer-readable storage medium and automatically send the data to the transmitter device or a computer at the end of the theater performance. The computer can be configured to post-process the received telemetry data by, for example, generating charts or performing statistical analysis of the telemetry data to identify communication problems, weak coverage areas, impact of transmitter device antenna design, etc. The one or more types of information can further include, for example, a battery level indicator 412, a count of cues received 414, or a count of data packets received from the transmitter device 416.

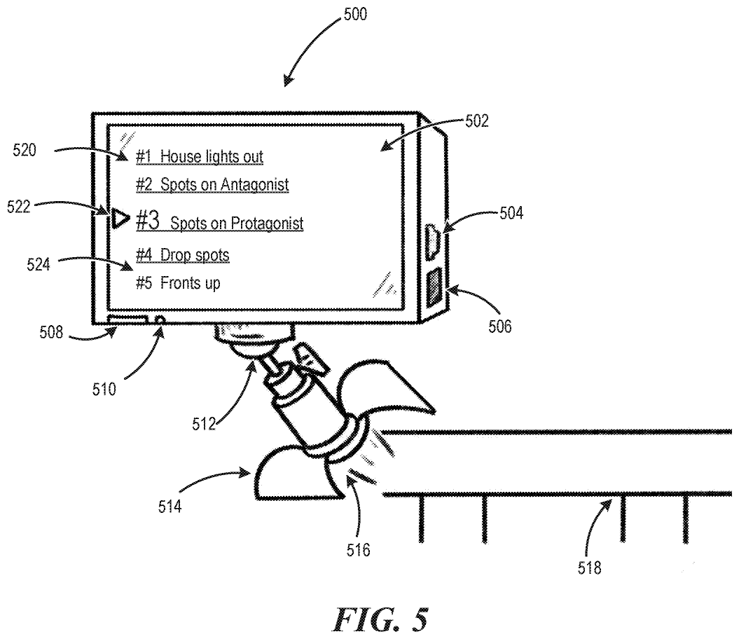

FIG. 5 shows another example embodiment of a receiver device 500 in which aspects of the disclosed technology are implemented. The receiver device 500 can have a large form factor, for example, when the receiver device 500 is intended for a stationary use, such as, for example, alerting actors in a backstage dressing room to received cues. In some embodiments, the receiver device can include one or more coupling mechanisms for coupling the receiver device 500 to another object, such as, for example, a railing 518. The railing 518 can be, for example, a metallic railing associated with catwalk lighting. In some embodiments, the one or more coupling mechanisms can include one or more magnets 516 to facilitate quick and easy coupling and decoupling to the railing 518. In some embodiments, the one or more magnets 516 can be rare-earth neodymium magnets. In some embodiments, the one or more coupling mechanisms can include one or more clamps 514 to facilitate firm and stable coupling to the railing 518. The receiver device 500 can include a screen 502 on which additional information or multimedia-rich content related to a received cue or related to the theater production can be displayed. In some embodiments, the screen 502 can be a large, tablet-like screen. In some embodiments, the screen 502 can be an OLED display. In some embodiments, the screen 502 can be a touchscreen that can receive touch inputs from a user of the receiver device 500. The information displayed on the screen 502 can include, for example, one or more previously received cues 520, a current cue 522, or one or more upcoming cues 524.

In some embodiments, the screen 502 can be coupled to a flexible mechanism, such as, for example, a ball and socket joint 512 that allows the screen 502 to be oriented in different directions. The receiver device 500 can include a data transfer and charging port 506 for transferring data to or from the receiver device 500. In some embodiments, the data transfer and charging port 506 can be a USB port—for example, a USB Type A, USB Type C, etc. port. The receiver device 500 can be configured to maintain operation through power outages by receiving power from a plurality of sources, such as, for example, an alternating current (AC) power supply from a power outlet and a direct current (DC) power supply from a battery that is internal or external to the receiver device 500. The receiver device 500 can communicate with a computer coupled to the receiver device 500 via the data transfer and charging port 506. The receiver device 500 can include a power switch 508 for turning the receiver device 500 on or off. The receiver device 500 can include a notification light 510 for visually alerting the user to various events related to the receiver device 500. The various events related to the receiver device 500 can include, for example, reception of a new cue or an operational error. The notification light 510 can alert the user in multiple ways, for example, by emitting light in a steady or a blinking pattern. In some embodiments, the notification light 510 can be a light-emitting diode (LED).

The receiver device 500 can include a video port 504 for sending or receiving video signals to or from another device. In some embodiments, the video port 504 can be a high-definition multimedia interface (HDMI) port that can receive video signals to be displayed on the screen 502 or can send video signals for displaying on an external screen coupled to the video port 504. The receiver device 500 can include an internal antenna and communication components for communicating with other transmitter or receiver devices. In some embodiments, the receiver device 500 can perform bidirectional communication with other transmitter or receiver devices, for example, by receiving cues from a transmitter device or sending cues to another receiver device. In some embodiments, the receiver device 500 can send positive acknowledgment messages to the transmitter device to indicate successful reception of a cue or other data or send negative acknowledgment messages to the transmitter device to indicate unsuccessful reception of a cue or other data, respectively. In some embodiments, the receiver device 500 can perform a repeater function to send cues received from the transmitter device to other receiver devices. The receiver device 500 can display on screen 502 a status associated with the theater production.

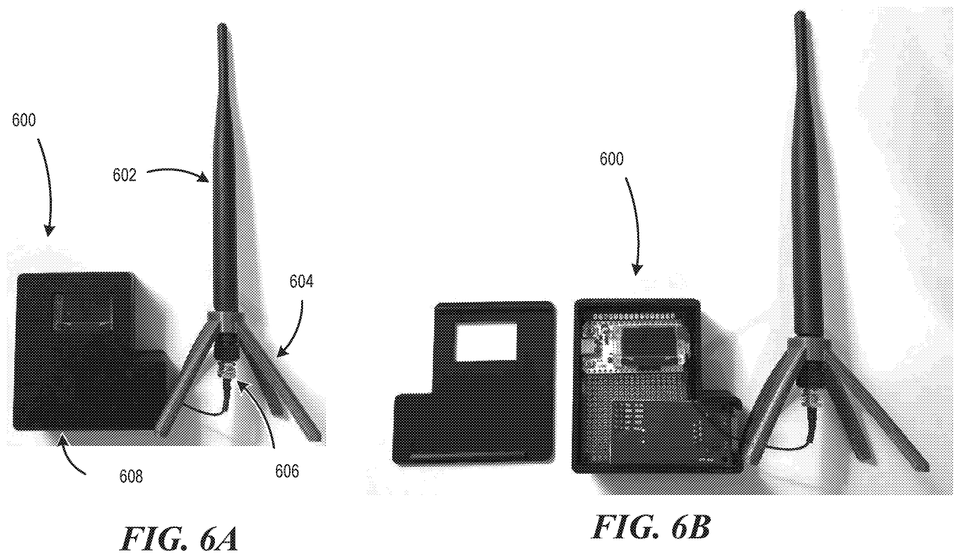

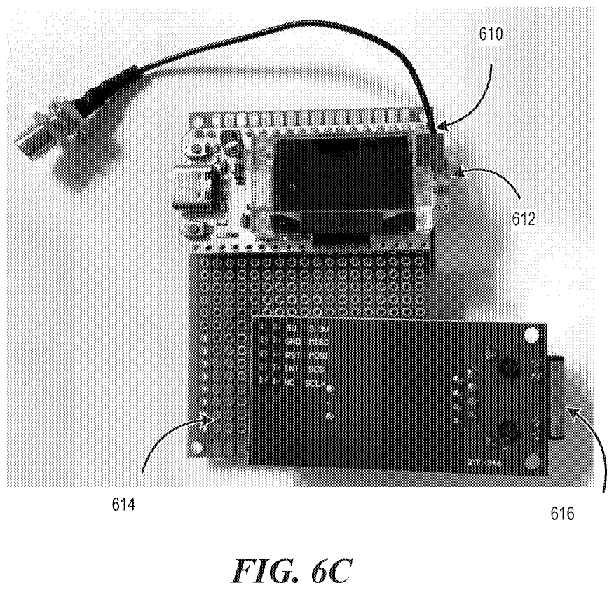

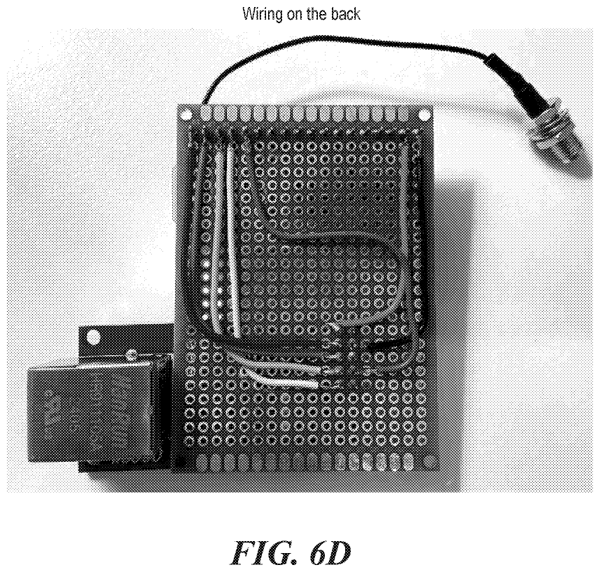

FIG. 6A shows an example embodiment of a transmitter device 600 in which aspects of the disclosed technology are implemented. FIGS. 6B-6D show various components of the transmitter device 600 in which aspects of the disclosed technology are implemented. The transmitter device 600 can be coupled to an antenna 602. In some embodiments, when the transmitter device 600 operates using LoRaWAN protocols and techniques, the antenna 602 can be a LoRaWAN antenna. The antenna 602 can be coupled to an antenna stand 604 that can enable the antenna 602 to be positioned or oriented appropriately to increase the signal strength of signals transmitted or received by the antenna 602. In some embodiments, the antenna stand 604 can be made of a flexible thermoplastic polyurethane (TPU) material. The antenna 602 can include an antenna connector 606. In some embodiments, the antenna connector 606 can be, for example, a coaxial sub-miniature version A (SMA) connector. In some embodiments, an external casing of the transmitter device 600 can include a removable lid 608, through which internal components of the transmitter device 600 can be accessed, for example, for servicing or troubleshooting problems with the transmitter device 600.

In some embodiments, the transmitter device 600 can include a controller board 610 to which various components, including a display, a communication module, and antenna 602, are coupled. In some embodiments, the display coupled to the controller board 610 can be an OLED display. In some embodiments, the controller board 610 can be an MCU board. In some embodiments, when the transmitter device 600 operates using LoRaWAN protocols and techniques, the communication module coupled to the controller board 610 can be a LoRaWAN communication module. The controller board 610 can include an antenna connector port 612 to which the antenna connector 606 of the antenna 602 is coupled. In some embodiments, the antenna connector port 612 can be, for example, a U.FL™ connector. In some embodiments, the controller board 610 can be coupled to a circuit board 614, such as, for example, a printed circuit board, through which electrical connections among various components of the transmitter device 600 are made. The transmitter device 600 can include a communications port 616 for connecting to other communication devices or computers. In some embodiments, the communications port 616 can be, for example, an Ethernet port.

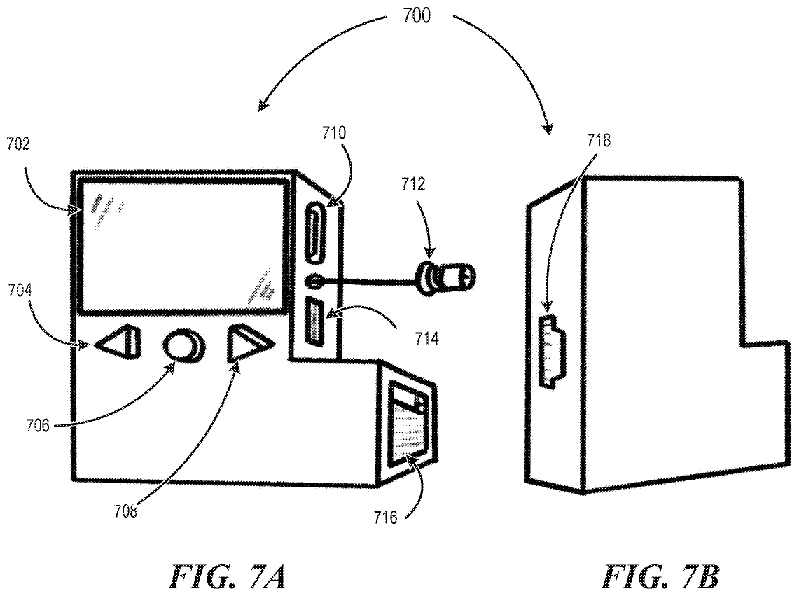

FIGS. 7A and 7B, respectively, show a front view and a back view of an example embodiment of a transmitter device 700 in which aspects of the disclosed technology are implemented. The transmitter device 700 can include a screen 702 for displaying cues or other information related to the operation of the transmitter device 700. In some embodiments, the screen 702 can be an OLED display. The transmitter device 700 can include input interfaces, for example, buttons, for receiving inputs from a user. The user inputs can include, for example, commands associated with navigating through a list of cues displayed on the screen of the transmitter device, selecting a cue, or sending a cue to receiver devices. For example, the transmitter device 700 can include a previous cue button 704 and a next cue button 708 for the user to navigate backward or forward, respectively, through cues stored in the transmitter device 700. The transmitter device 700 can include an interaction button 706 for making a selection or changing a configuration setting of the transmitter device 700. The transmitter device 700 can include a data transfer and charging port 710 for transferring data between the transmitter device 700 and a computer. In some embodiments, the data transfer and charging port 710 can be a USB port—for example, a USB Type A, USB Type C, etc. port. The transmitter device 700 can be coupled to an antenna connector 712. In some embodiments, the antenna connector 712 can be, for example, a coaxial SMA connector. The transmitter device 700 can include a memory card reader interface 714 for reading or writing data from a memory card. In some embodiments, the memory card reader interface 714 can be, for example, a Secure Digital (SD) card reader. The transmitter device 700 can include a communications port 716 for connecting to other communication devices or computers. In some embodiments, the communications port 716 can be, for example, an Ethernet port. The transmitter device 700 can further include wireless communications interfaces, such as Wi-Fi or Bluetooth, for connecting to a computer or other compatible devices wirelessly. The transmitter device 700 can include a video port 718 for sending or receiving video signals to or from another device. In some embodiments, the video port 718 can be an HDMI port that can receive video signals to be displayed on the screen 702 or can send video signals for displaying on an external screen coupled to the video port 718. The transmitter device 700 can be configured to maintain operation through power outages by receiving power from a plurality of sources, such as, for example, an alternating current (AC) power supply from a power outlet and a direct current (DC) power supply from a battery that is internal or external to the transmitter device 700.

In some embodiments, the transmitter device 700 can operate in a standalone manner without connecting to a computer during a theater performance. For example, cues associated with various backstage teams can be stored in the transmitter device 700 in advance of the performance. The user, for example, a stage manager, can navigate through the stored cues, select a cue for sending to receiver devices, and send the cue using the previous cue button 704, the next cue button 708, or the interaction button 706. In some embodiments, the transmitter device 700 can operate in combination with a computer during the theater performance, for example, by maintaining a connection to the computer during the performance and sending cues received from the computer to receiver devices via the antenna 602. In some embodiments, the transmitter device 700 can receive spoken cues, for example, via communications port 716, wireless communications interfaces, such as Wi-Fi or Bluetooth, or via a microphone coupled to the transmitter device 700. The transmitter device 700 can convert the received spoken cues to textual cues using speech-to-text algorithms and send the textual cues to receiver devices via the antenna 602. For example, when the user says “Deck cue 1, Go,” the transmitter device 700 can send a first Deck cue to the receiver devices.

The transmitter device 700 can send cues to receiver devices securely by encrypting the cues before transmission. In some embodiments, the transmitter device 700 can be configured to send each cue, or each data packet containing a part of a cue, a plurality of times to increase the chances of receiver devices successfully receiving the cue. In some embodiments, the transmitter device 700 can be configured to send data packets, for example, data packets containing cues, at a high speed but with low reliability. In some other embodiments, the transmitter device 700 can be configured to send data packets, for example, data packets containing cues, at a low speed but with high reliability. In some embodiments, multiple transmitter devices can be communicatively coupled to each other to expand their coverage range and transmit cues to receiver devices over longer distances.

The transmitter device 700 can interoperate with common computer theatrical control system application program interfaces (APIs), such as, for example, open source control (OSC) for controlling theater equipment, such as lights, speakers, etc. The transmitter device 700 can interoperate with theater equipment that comprises serial communication interfaces. In some embodiments, the transmitter device 700 can interoperate with commercial cue management software programs, such as, for example, QLab™. In some embodiments, the transmitter device 700 can communicate with receiver devices or a computer connected to the transmitter device 700's communication interface using user datagram protocol (UDP). In addition to sending cues stored in the transmitter device 700 in advance of the performance, the transmitter device 700 can receive new cues or modifications to stored cues in real time or near-real time from the computer connected to the transmitter device 700, such as, for example, cues related to emergency in-show fixes generated by the stage manager in response to events during the performance. In some embodiments, in addition to sending regular theater performance-related cues, the transmitter device 700 can send operational, administrative, or management commands or cues to receiver devices. The operational, administrative, or management commands or cues can include, for example, timer cues, receiver device configuration commands, commands to report telemetry data, emergency hold cues, etc. The operational, administrative, or management commands or cues can also include, for example, a command to assign the receiver device to a first backstage team or a command to reassign the receiver device from a first backstage team to a second backstage team.

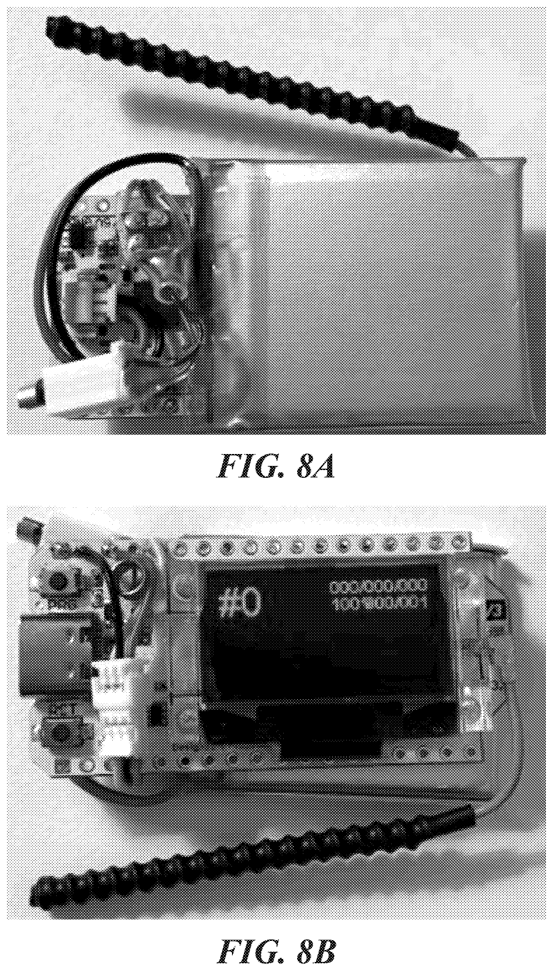

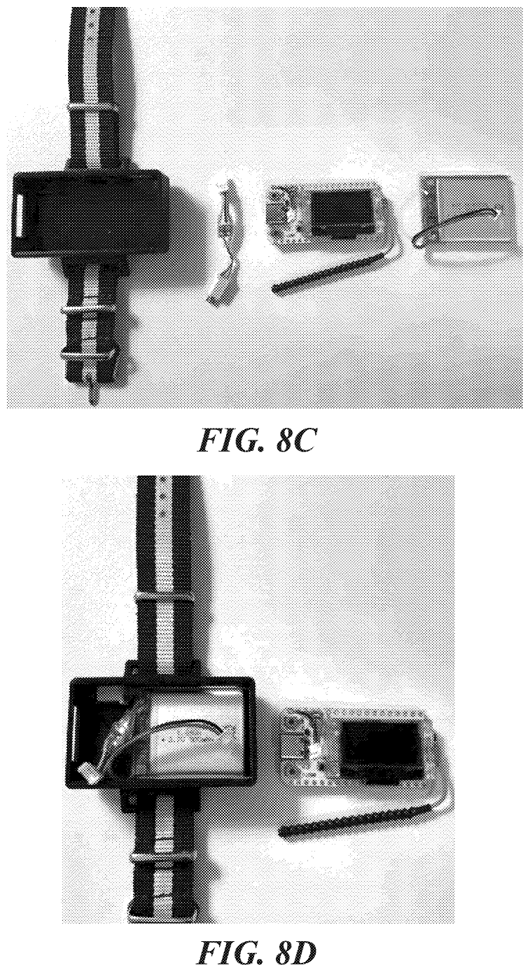

FIGS. 8A-8D show various components of an example embodiment of a wearable device in which aspects of the disclosed technology are implemented.

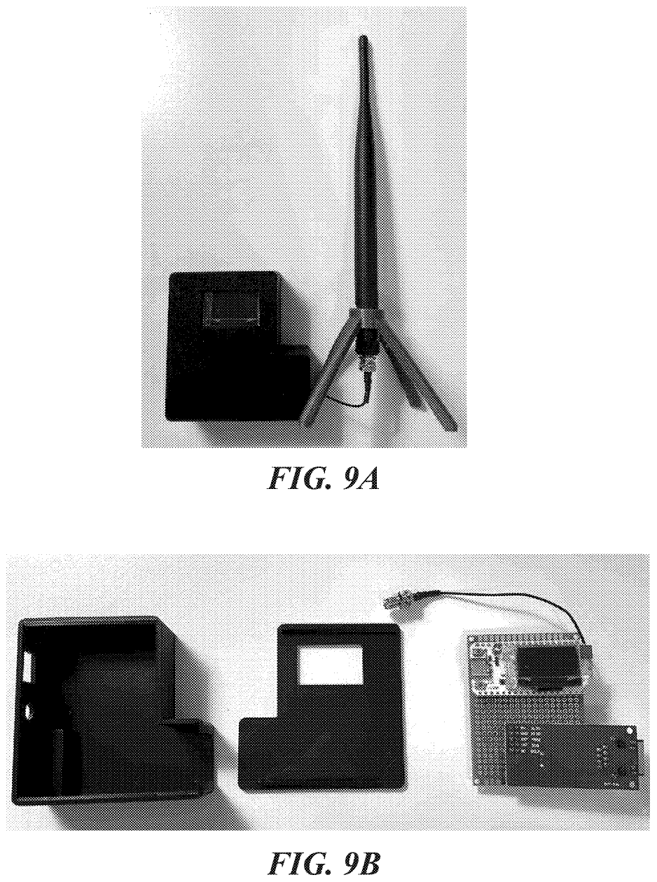

FIGS. 9A and 9B show various components of an example embodiment of a transmitter device in which aspects of the disclosed technology are implemented.

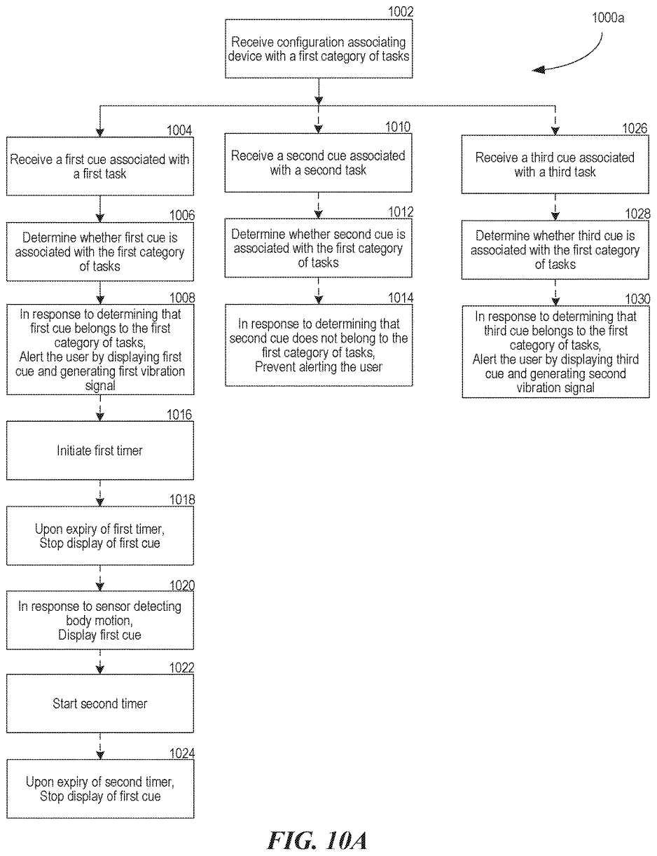

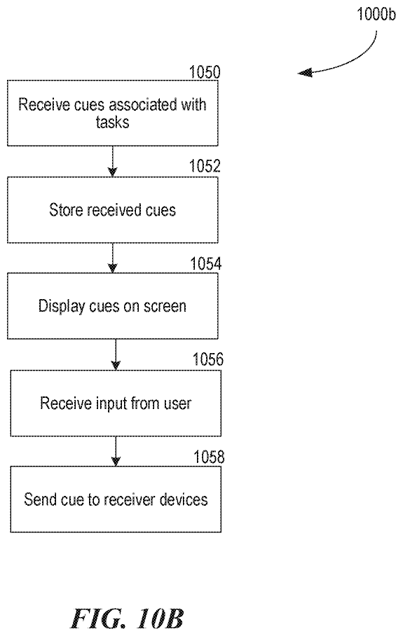

FIG. 10A shows a flowchart of an example method 1000a in which aspects of the disclosed technology are implemented. The method 1000a can be implemented for processing cues received by a receiver device during a theater performance. The receiver device can include a screen, a haptic motor, at least one wired communication interface, and at least one wired communication interface. In some implementations, the at least one wireless communication interface is configured to operate in compliance with long range wide area network (LoRaWAN) communication protocols. In some implementations, the receiver device can further comprise an ultraviolet (UV) light source. The receiver device can be configured to receive a configuration over the at least one wired or wireless communication interfaces. The configuration can associate the receiver device with a category of tasks related to the theater performance. The receiver device can be further configured to alert a user of the receiver device about cues belonging to the category of tasks related to the theater performance that the receiver device is associated with.

At 1002, the receiver device receives, over the at least one wired or wireless communication interfaces, a configuration associating the receiver device with a first category of tasks related to the theater performance. At 1004, the receiver device receives, over the at least one wireless communication interface, a first cue associated with a first task related to the theater performance. The first cue is further associated with a first identifier. At 1006, the receiver device determines whether the first cue belongs to the first category of tasks. At 1008, in response to determining that the first cue belongs to the first category of tasks, the receiver device alerts the user about the first cue. Alerting the user about the first cue comprises displaying the first cue, the first identifier, or a text string associated with the first cue on the screen and generating, from the haptic motor, a first vibration signal associated with the first cue.

In some implementations, at 1010, the receiver device receives, over the at least one wireless communication interface, a second cue associated with a second task related to the theater performance. The second cue is further associated with a second identifier. At 1012, the receiver device determines whether the second cue belongs to the first category of tasks related to the theater performance. At 1014, the receiver device, in response to determining that the second cue does not belong to the first category of tasks, prevents alerting the user about the second cue.

In some implementations, at 1016, in response to displaying the first cue, the first identifier, or the text string, the receiver device initiates a first timer. In some implementations, at 1018, upon expiry of the first timer, the receiver device reduces energy consumption of the receiver device by stopping the display of the first cue, the first identifier, or the text string on the screen. In some implementations, at 1020, in response to a sensor of the receiver device detecting a body motion of the user, the receiver displays the first cue, the first identifier, or the text string on the screen. At 1022, the receiver device initiates a second timer. At 1024, upon expiry of the second timer, the receiver device stops the display of the first cue, the first identifier, or the text string on the screen. In some implementations, the sensor can be an accelerometer.

In some implementations, at 1026, the receiver device can receive, over the at least one wireless communication interface, a third cue associated with a third task related to the theater performance. The third cue is further associated with a third identifier. At 1028, the receiver can determine whether the third cue belongs to the first category of tasks related to the theater performance. At 1030, in response to determining that the third cue belongs to the first category of tasks, the receiver device can alert the user about the third cue. Alerting the user about the third cue comprises displaying the third cue, the third identifier, or a text string associated with the third cue on the screen and generating, from the haptic motor, a second vibration signal associated with the third cue.

FIG. 10B shows a flowchart of an example method 1000b in which aspects of the disclosed technology are implemented. The method 1000b can be implemented in a device for sending cues to receiver devices during a theater performance. The device can include at least one non-transitory, computer-readable storage medium, at least one screen, at least one wired interface, at least one wireless communication interface, and at least one input interface for receiving inputs from a user of the device. In some implementations, the at least one wireless communication interface can be configured to operate in compliance with long range wide area network (LoRaWAN) communication protocols. In some implementations, the at least one wired interface can comprise an Ethernet communication interface, a universal serial bus (USB) interface, or a digital memory card reader interface.

At 1050, the device receives, over the at least one wired interface or the at least one wireless communication interfaces, cues associated with tasks related to the theater performance. Each cue is associated with an identifier and a task category. At 1052, the device stores the received cues in the at least one non-transitory, computer-readable storage medium of the device. At 1054, the device displays a list of stored cues, identifiers, or tasks on the screen of the device. At 1056, the device receives an input via the input interface from the user. The input comprises a selection of a first cue, a first identifier associated with the first cue, or a first task associated with the first cue. At 1058, the device sends the first cue, the first identifier, or the first task to receiver devices via the at least one wireless communication interface. In some implementations, sending the first cue, the first identifier, or the first task to receiver devices via the at least one wireless communication interface can further comprise repeatedly transmitting the first cue, the first identifier, or the first task a first threshold number of times, with each repeated transmission of the first cue, the first identifier, or the first task being separated by a second threshold period of time.

### Computer System

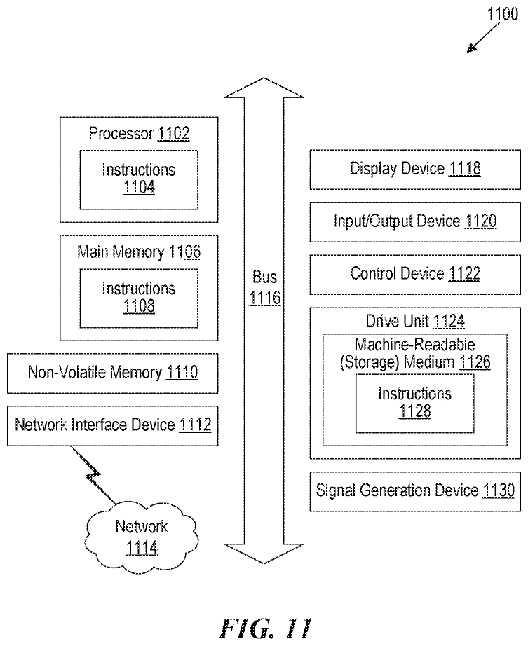

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a video display device 1118, an input/output device 1120, a control device 1122 (e.g., keyboard and pointing device), a drive unit 1124 that includes a machine-readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computing system 1100 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1100. In some implementations, the computer system 1100 can be an embedded computer system, a system-on-chip (SOC), a single-board computer system (SBC), or a distributed system such as a mesh of computer systems, or it can include one or more cloud components in one or more networks. Where appropriate, one or more computer systems 1100 can perform operations in real time, in near real time, or in batch mode.

The network interface device 1112 enables the computing system 1100 to mediate data in a network 1114 with an entity that is external to the computing system 1100 through any communication protocol supported by the computing system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computing system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computing system 1100 to perform operations to execute elements involving the various aspects of the disclosure.

### Location Tracking

In some embodiments, the disclosed technology includes a wearable receiver device that can include necessary hardware and software components to determine a current location of the wearable receiver device for precisely tracking a location of the wearer as the wearer moves about in the theater. In some embodiments, the hardware and software components for precise location tracking can include a communications module that uses ultra-wideband (UWB) technology. In some embodiments, the disclosed technology can include multiple location anchors positioned around the theater and/or the stage for sensing distance and/or angle of approach of the wearable receiver device from the respective location anchor for determining the precise location of the wearable receiver device. In some embodiments, the disclosed technology additionally includes a software program that can simultaneously track locations of multiple wearable receiver devices. In some embodiments, the software program can plot real-time locations of each of the multiple wearable receiver devices on a map displayed on a computer screen. In some embodiments, the software program can display a path of a wearable receiver device around the theater or the stage as a wearer of the wearable receiver device moves about during the theater performance. In some embodiments, the wearable receiver device can generate a vibration signal from a haptic motor when a wearer of the wearable receiver device reaches a predetermined location on the stage. In some embodiments, the wearable receiver device can be configured to geofence the stage by, for example, generating a recognizable vibration signal when the wearer approaches an edge of the stage. In some embodiments, the wearable receiver device can include an inductive charging coil for charging the wearable receiver device wirelessly.

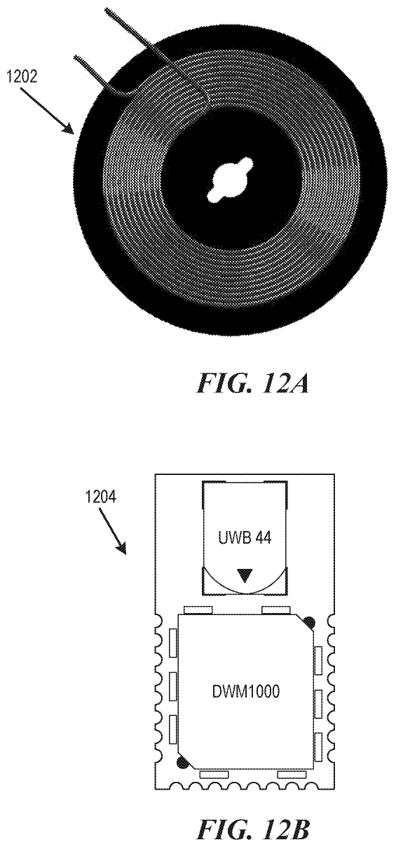

FIG. 12A shows an example of an inductive charging coil 1202 that can be included in some embodiments of the disclosed technology. The inductive charging coil 1202 can be configured to wirelessly charge the energy source 314 for powering operations of the wearable receiver device.

FIG. 12B shows an example of an ultra-wideband (UWB) communications module 1204, for example, a UWB radio, that can be included in some embodiments of the disclosed technology. UWB communications, as used herein, refer to radio communications employing extremely wide instantaneous bandwidths (e.g., greater than 500 MHz or exceeding 20% fractional bandwidth) to transmit low-power, short-duration pulses over a designated spectrum. In some embodiments, the UWB communications module 1204 comprises a pulse generator, a wideband front end, and a timing subsystem configured to emit and detect time-resolved signals characterized by high temporal resolution. By distributing energy across a broad frequency range, UWB communications can achieve robust multipath resilience, reduced interference susceptibility, and precise ranging for accurately tracking a position of the wearer of the wearable receiver device in real time.

The UWB communications module 1204 generates a sequence of modulated pulses, for example, binary phase-coded, time-hopped, or pulse-position modulated impulses, and transmits the same through a UWB-compatible antenna coupled to the UWB communications module 1204. The UWB communications module 1204 implements correlation or matched filtering against a template waveform and estimates time of arrival (TOA) and/or time difference of arrival (TDOA) with sub-nanosecond precision. In some implementations, a clocking module included in the UWB communications module 1204 can provide deterministic timing references to align pulse emissions across channels, while a digital signal processor can extract channel impulse responses to resolve multipath components and derive range estimates, angle-of-arrival (AoA), and channel quality metrics.

In some embodiments, the UWB communications module 1204 can perform ranging by transmitting a first pulse burst to a location anchor, receiving a response burst with embedded timestamps, computing a round-trip time, and compensating for clock drift, temperature variation, and oscillator offset to obtain calibrated distance. In some embodiments, when multiple location anchors are deployed at various locations around the theater and/or the stage, trilateration or multi-lateration algorithms, optionally coupled with inertial measurements, can determine a three-dimensional position of the wearer with decimeter or better accuracy.

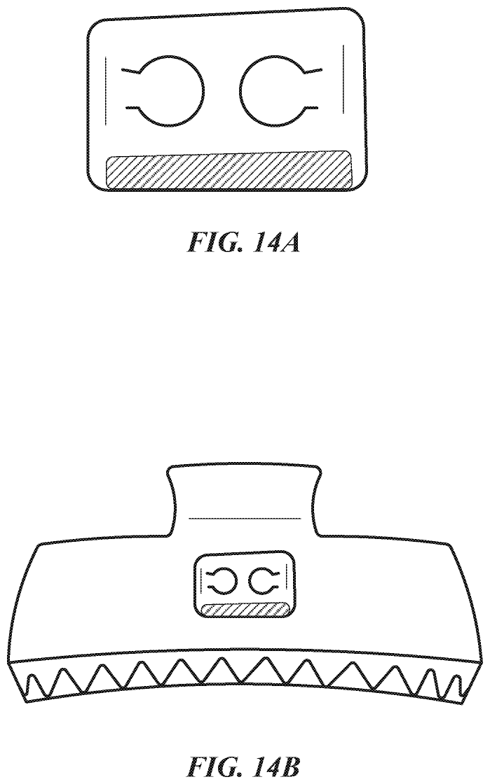

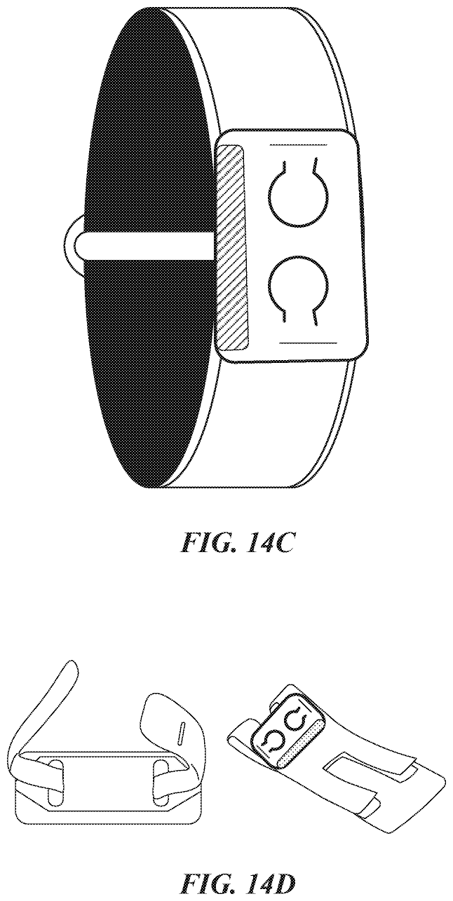

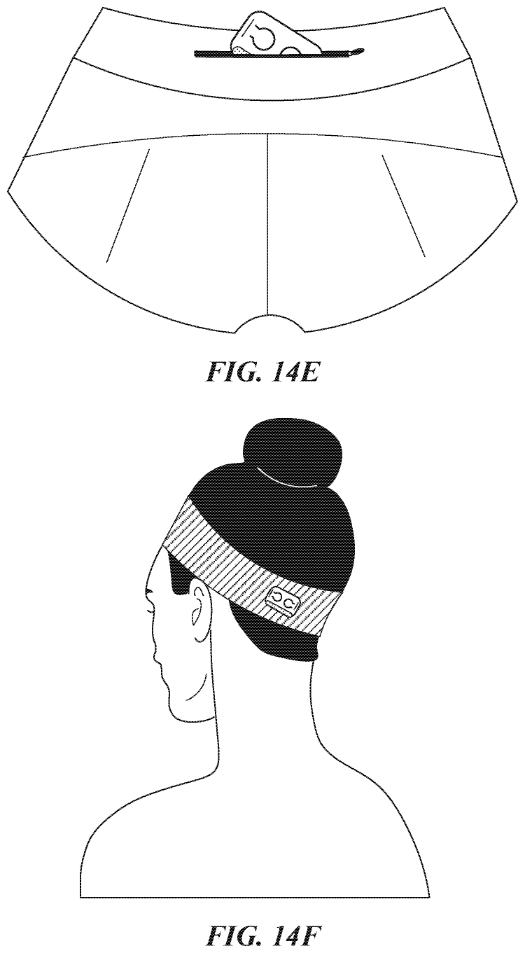

FIGS. 14A-14F show additional example embodiments of wearable receiver devices in which aspects of the disclosed technology are implemented. In some embodiments, the wearable receiver device can include a haptic motor and an ultra-wideband (UWB) communications module but exclude a display screen. In some embodiments, for example, as shown in FIG. 14A, the wearable receiver device can have a miniature module form factor that can be disposed in various clothing or clothing accessory items. In some embodiments, certain parts or edges of the wearable receiver device can have curved shapes to improve fitment when worn by performers. In some embodiments, the wearable receiver device can include one or more buttons to allow the wearer to interact with the wearable receiver device. In some embodiments, the wearable receiver device can be adapted to be coupled to a variety of mounts. In some embodiments, for example, the embodiment shown in FIG. 14B, the wearable receiver device can be mounted to a hair clip. In some embodiments, for example, the embodiment shown in FIG. 14C, the wearable receiver device can be coupled to a band, for example, a sports band, that can be worn on a limb or a torso of the wearer. In some embodiments, for example, the embodiment shown in FIG. 14D, the wearable receiver device can include clip or Velcro mounts for coupling the device to various objects, for example, objects whose movement is to be tracked. In some embodiments, for example, the embodiment shown in FIG. 14E, the wearable receiver device can have a form factor that allows the wearable receiver device to fit into clothing pockets, for example, small pockets of popular dancewear. In some embodiments, for example, the embodiment shown in FIG. 14F, the wearable receiver device can have a form factor and/or necessary attachment interfaces that allow the wearable receiver device to be placed in a pouch, for example, at the back of a headband worn by the wearer. These are merely illustrative examples and are not to be considered as limiting. The wearable receiver device can take various suitable form factors that enable the wearable receiver device to be coupled to various clothing or accessory items used in relation to a theater performance.

### Example Use Case 1: Automatically Capturing a Show's Choreography

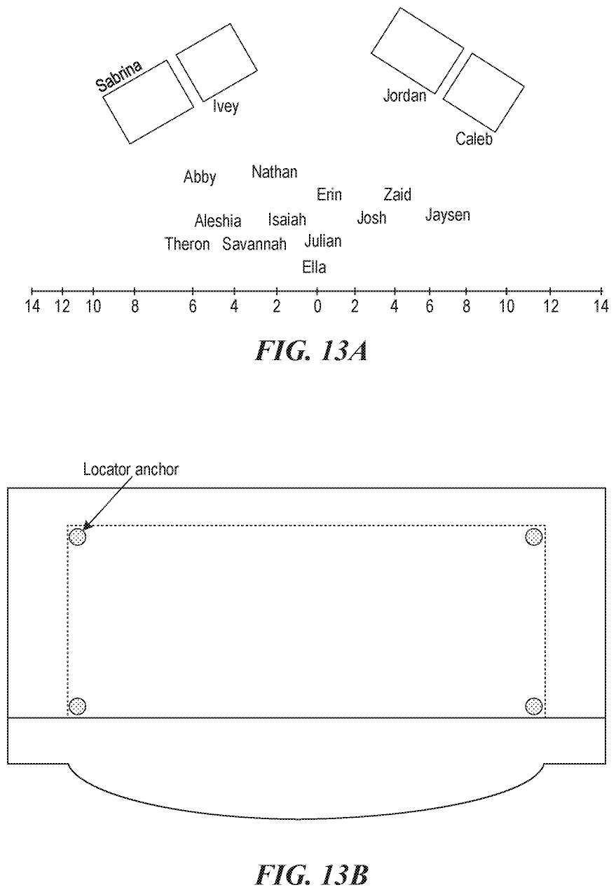

FIG. 13A shows an example of a formation diagram of stage performers associated with a theater performance. A typical theater performance presents a heavy and complex workload for the show's choreographer. In one example, the workload can include about 13 songs and 20 formations or transitions. The choreographer can be tasked with generating a respective formation diagram for each of the songs, formations, or transitions to indicate positions of various performers on the stage during each song, formation, or transition. Choreographing each song can take, for example, up to two and a half hours and can require the choreographer to draw the formation diagram for the song by hand. Creating formation diagrams for formations and transitions can be similarly time-consuming.

FIG. 13B shows a plan view of an example implementation of location anchors in which aspects of the disclosed technology are implemented. In some embodiments, a single location anchor can be implemented. In some embodiments, multiple location anchors can be implemented at various locations around the stage to track locations of performers as they move about the stage. In some embodiments, the multiple location anchors can be positioned at or near, for example, four corners of the stage. Multiple performers or objects to be tracked can wear their respective wearable receiver devices that each include ultra-wideband (UWB) communications modules and perform their songs, formations, or transitions as planned. Each wearable receiver device can communicate with one or more of the multiple location anchors using UWB frequencies and protocols. A base station coupled to the one or more location anchors can determine a precise real-time location of each performer based on the relative position of the performer's wearable receiver device from the one or more location anchors. In some embodiments, a software program implemented on the base station or a computer coupled to the base station can display, on a screen of the base station or the computer, a live view of every performer on the stage based on the performer's location as determined above. The choreographer can thereby be enabled to capture, for example, screenshots of the performers'positions to create formation diagrams for choreographing the song, formation, or transition as necessary.

### Example Use Case 2: Showing Track of a Performer or Object

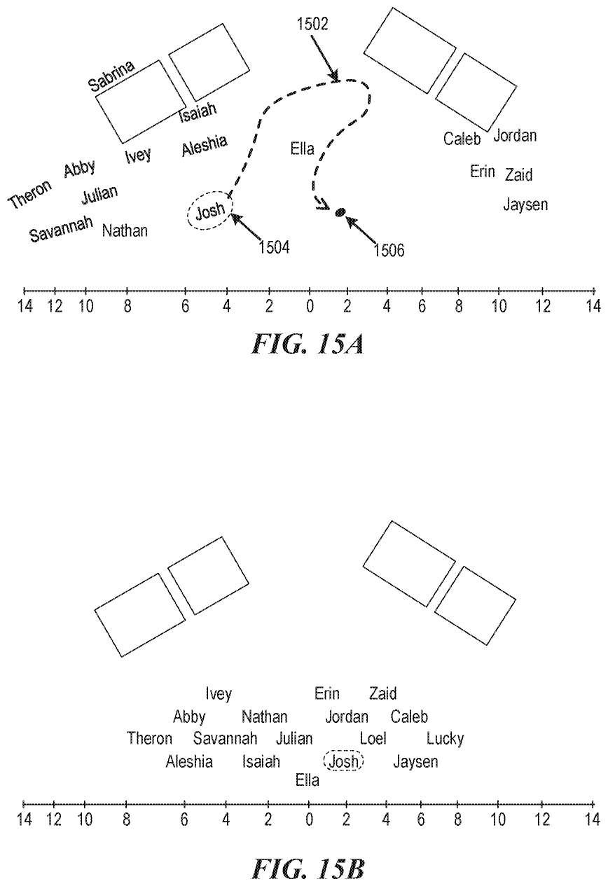

FIGS. 15A and 15B show example implementations of the disclosed technology for location tracking of stage performers during a theater performance. A track, as referred to herein, is a path followed by a performer through the show. Knowing the path followed or to be followed on stage during the performance can be important, for example, for substitute performers who may have limited familiarity with or limited time to prepare for the performance. Ordinarily, such tracks are generated manually and can be inaccurate and/or time-consuming. When aspects of the disclosed technology are implemented, a software program implemented on the base station or a computer coupled to the base station can be configured to receive location information of the one or more performers wearing wearable receiver devices comprising UWB communications modules. The software program can be configured to generate a track for each of the one or more performers. FIG. 15A, for example, shows an example of a track 1502 generated using the disclosed technology to assist a performer 1504 reach a desired spot 1506 in a scene of the show. FIG. 15B, for example, shows a location of the performer 1504 on the stage in relation to other performers on the stage.

### Example Use Case 3: Directing Haptic Cues to Performers

In some embodiments, the disclosed technology can be used to train or direct one or more performers to reach a desired spot on the stage. For example, a wearable receiver device can be configured to alert its wearer by generating a vibration signal from the haptic motor when the wearer reaches a predetermined location on the stage. In some embodiments, the wearable receiver device can be configured to alert its wearer by generating the vibration signal from the haptic motor when the wearer reaches an approximate location, which is defined by a threshold distance around the predetermined location on the stage. Such disclosed functionality can be implemented, for example, for directing young performers to their positions on the stage or to reduce the time taken by performers to learn their positions. In some embodiments, the wireless receiver device can be configured to help avoid accidents by alerting its wearer by generating a vibration signal from the haptic motor, for example, when the wearer approaches a set piece on the stage or a dangerous object, for example, heavy or high voltage stage equipment, etc. In some embodiments, the vibration signal can be configured to increase in intensity or change a vibration pattern as the wearer approaches the set piece or dangerous object.

### Example Use Case 4: Haptic Feedback Geofencing

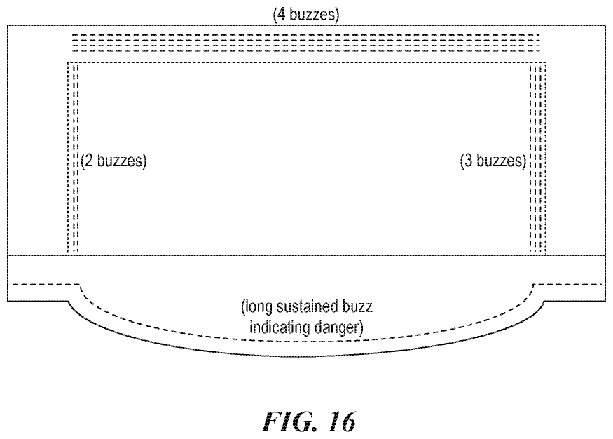

FIG. 16 shows an example implementation of the disclosed technology for geofencing an area in a theater during a theater performance. Aspects of the disclosed technology are implemented to enable, for example, visually impaired individuals to perform in shows. Visually impaired individuals can, for example, be enabled to freely move about the stage while ensuring their safety by defining one or more geofences near, for example, the performance area, dangerous objects, or one or more edges of the stage, and alerting the individuals of dangerous situations, for example, when they approach the dangerous objects or the one or more stage edges. In some embodiments, the wearable receiver device can be configured to generate multiple different vibration signals, each associated with a respective dangerous situation. In some embodiments, for example, the wearable receiver device can be configured to alert the wearer by generating a first vibration signal, for example, a first vibration pattern, for example, two buzzes, from the haptic motor when the wearer approaches a first area of the stage. In some embodiments, for example, the wearable receiver device can be configured to alert the wearer by generating a second vibration signal, for example, a second pattern, for example, three buzzes, from the haptic motor when the wearer approaches a second area of the stage. In some embodiments, for example, the wearable receiver device can be configured to alert the wearer by generating a third vibration signal that is different from the first and the second vibration signals, for example, a third vibration pattern, for example, four buzzes, from the haptic motor when the wearer approaches a third area of the stage. In some embodiments, for example, the wearable receiver device can be configured to alert the wearer by generating a fourth vibration signal that is different from the first three vibration signals, for example, a fourth vibration pattern, for example, a sustained buzz, to alert the wearer when the wearer approaches a dangerous situation such as, for example, an edge of the stage. These are merely illustrative examples and are not to be considered as limiting. The count and variety of vibration signals generated by the wearable receiver device to alert the wearer can vary according to different implementations of the disclosed technology.

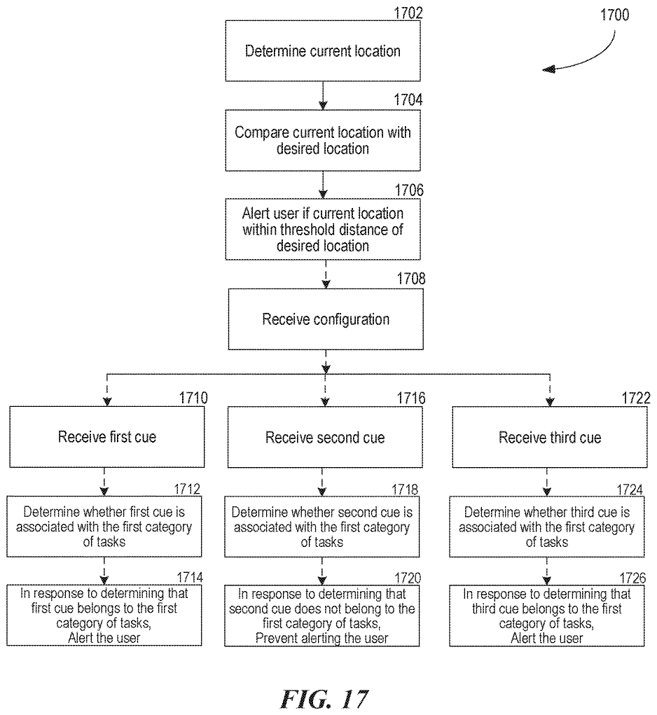

FIG. 17 shows a flowchart of a process 1700 in which aspects of the disclosed technology are implemented. The process is implemented in a wearable device for processing cues received during a theater performance. The wearable device comprises at least one hardware processor, at least one non-transitory, computer-readable storage medium, a haptic motor, at least two communication interfaces, and at least one non-transitory memory storing instructions that are executed by the at least one hardware processor. In some embodiments, the wearable device is configured to receive, over at least a first communication interface of the at least two communication interfaces, a configuration associating the wearable device with a category of tasks related to the theater performance. In some embodiments, the first communication interface is a wireless communication interface configured to operate in compliance with long-range (also referred to herein as long range) wide area network (LoRaWAN) communication protocols. In some embodiments, the second communication interface is a wireless communication interface configured to operate in compliance with ultra-wideband (UWB) communication protocols.

In some embodiments, the wearable device is configured to alert a user of the wearable device about cues belonging to the category of tasks that the wearable device is associated with. In some embodiments, the wearable device is configured to receive the cues over the first communication interface of the at least two communication interfaces. In some embodiments, the wearable device is configured to determine a current location of the wearable device in relation to at least one location anchor disposed in the theater based on communication over a second communication interface of the at least two communication interfaces. In some embodiments, the wearable device is configured to receive a location of the wearable device determined by a base station.

At operation 1702, a current location of the wearable device in relation to the at least one location anchor disposed in the theater is determined. In some embodiments, the current location of the wearable device is determined by the wearable device. In some embodiments, the current location of the wearable device is determined by the base station and sent to the wearable device.

At operation 1704, the wearable device compares the current location of the wearable device with a desired location of the wearable device. At operation 1706, the wearable device, in response to determining that the current location of the wearable device is within a threshold distance from the desired location, alerts the user at least by generating, from the haptic motor, a vibration signal.

In some embodiments, at operation 1708, the wearable device can receive a configuration associating the wearable device with a first category of tasks related to the theater performance. In some embodiments, at operation 1710, the wearable device can receive a first cue associated with a first task related to the theater performance. The first cue can be further associated with a first identifier. In some embodiments, at operation 1712, the wearable device can determine whether the first cue belongs to the first category of tasks. In some embodiments, at operation 1714, the wearable device can, in response to determining that the first cue belongs to the first category of tasks, alert the user about the first cue. In some embodiments, alerting the user about the first cue can comprise at least generating, from the haptic motor, a first vibration signal associated with the first cue. In some embodiments, the wearable device can further comprise a screen. In some embodiments, alerting the user about the first cue can comprise displaying the first cue, the first identifier, or a text string associated with the first cue on the screen.

In some embodiments, at operation 1716, the wearable device can receive a second cue associated with a second task related to the theater performance. In some embodiments, the second cue can further be associated with a second identifier. In some embodiments, at operation 1718, the wearable device can determine whether the second cue belongs to the first category of tasks related to the theater performance. In some embodiments, at operation 1720, the wearable device can, in response to determining that the second cue does not belong to the first category of tasks, prevent alerting the user about the second cue. In some embodiments, at operation 1722, the wearable device can receive a third cue associated with a third task related to the theater performance. In some embodiments, the third cue can further be associated with a third identifier. In some embodiments, at operation 1724, the wearable device can determine whether the third cue belongs to the first category of tasks related to the theater performance. In some embodiments, at operation 1726, the wearable device can, in response to determining that the third cue belongs to the first category of tasks, alert the user about the third cue. In some embodiments, alerting the user about the third cue can further comprise generating, from the haptic motor, a second vibration signal associated with the third cue.

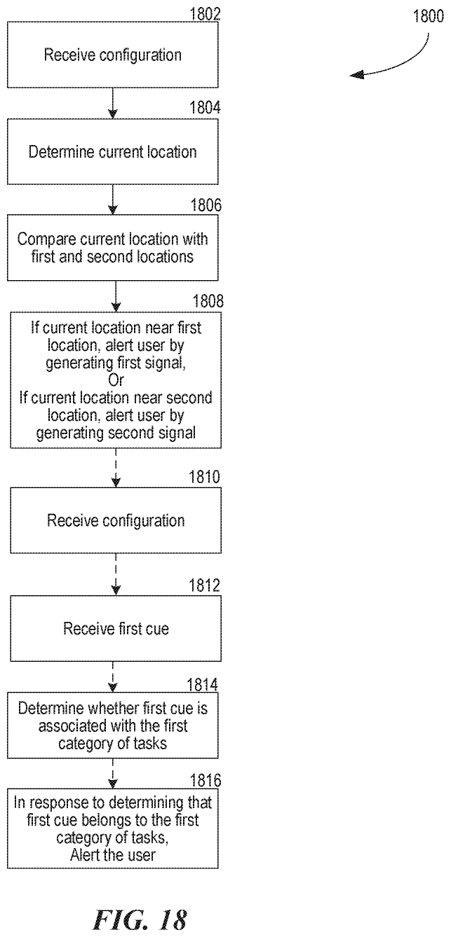

FIG. 18 shows a flowchart of a process 1800 in which aspects of the disclosed technology are implemented. The process 1800 can process cues received by a wearable device during a theater performance. In some embodiments, the wearable device can include a haptic motor and at least two communication interfaces. At operation 1802, the wearable device can receive, over at least a first communication interface of the at least two communication interfaces, a configuration associating the wearable device with a category of tasks related to the theater performance. The wearable device is configured to alert a user of the wearable device about cues belonging to the category of tasks that the wearable device is associated with. In some embodiments, the wearable device can be configured to receive the cues over the first communication interface of the at least two communication interfaces. At operation 1804, the wearable device can determine a current location of the wearable device in relation to at least one location anchor disposed in the theater based on communication over a second communication interface of the at least two communication interfaces. At operation 1806, the wearable device can compare the current location of the wearable device with at least a first location and a second location of the wearable device. At operation 1808, the wearable device can, in response to determining that the current location of the wearable device is within a threshold distance from the first location, alert the user at least by generating, from the haptic motor, a first vibration signal or, in response to determining that the current location of the wearable device is within the threshold distance from the second location, alert the user at least by generating, from the haptic motor, a second vibration signal.

In some embodiments, at operation 1810, the wearable device can receive a configuration associating the wearable device with a first category of tasks related to the theater performance. In some embodiments, at operation 1812, the wearable device can receive a first cue associated with a first task related to the theater performance. The first cue is further associated with a first identifier. In some embodiments, at operation 1814, the wearable device can determine whether the first cue belongs to the first category of tasks. In some embodiments, at operation 1816, the wearable device can, in response to determining that the first cue belongs to the first category of tasks, alert the user about the first cue at least by generating, from the haptic motor, a third vibration signal.

### Example Use Case 5: Choreography Capture

In some embodiments, the disclosed technology can be used to capture a choreography sequence such as dance movements performed by a wearer of the wearable device. In some embodiments, a device in which aspects of the disclosed technology are implemented can include instructions that can cause the device to extract, from a first video of the wearer performing the choreography sequence, a plurality of dance poses performed by the wearer during the choreography sequence. The instructions can be executed by the one or more processors 1102 of the device. In some embodiments, the instructions can be a software program installed on the device. In some embodiments, the instructions can cause the device to perform any of: recording the first video capturing the choreography sequence, refining the first video, for example, by removing background information such as objects other than the wearer in the first video to isolate the wearer, determining one or more poses of the wearer in the choreography sequence, and generating a second video.

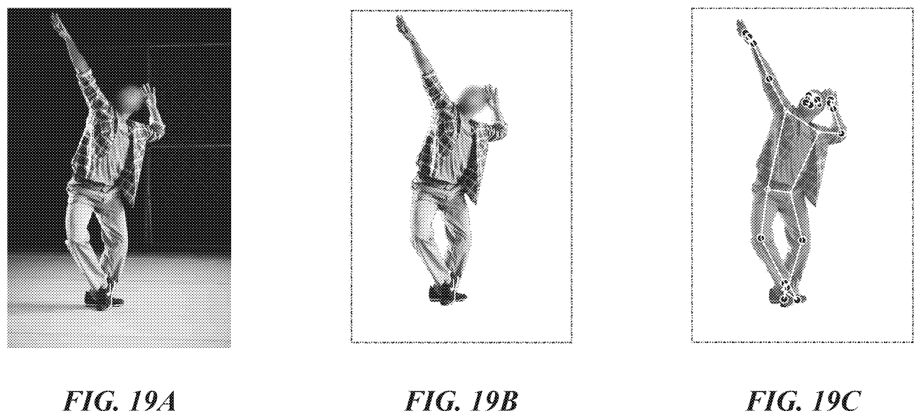

FIG. 19A shows an example of a first video captured by a device in which aspects of the disclosed technology are implemented. FIG. 19B shows an example of a body of interest, for example, the wearer, isolated from the first video captured by a device in which aspects of the disclosed technology are implemented. FIG. 19C shows an example of a pose of a body of interest, for example, the wearer, extracted from the first video captured by a device in which aspects of the disclosed technology are implemented. In some embodiments, the device can generate the second video by combining one or more locations of the wearer around the stage at various times, for example, as determined according to techniques described in Example Use Case 2 (Showing Track of a Performer or Object) of this patent application, with corresponding movements of the wearer in the first video at those times. In some embodiments, the device can generate the second video by combining the one or more locations of the wearer around the stage at various times with corresponding movements of the wearer after removing background objects and isolating the wearer at those times in the first video. In some embodiments, the device can generate the second video by combining the one or more locations of the wearer around the stage at various times with poses of the wearer extracted from the first video. The second video thus generated according to any of the aforementioned techniques can enable a choreographer to better visualize the movements of the wearer in the first video with precise location of the wearer around the stage corresponding to those movements. The choreographer is enabled to, based on the first and/or second videos, visualize and further plan the choreography sequence. Other members of the theatrical performance, for example, lighting designers, directors, sound designers, scenic designers, deck crew, stage management, etc., can also be enabled to plan their tasks directly based on the first and/or second videos without having to wait for inputs from other teams.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wearable device for processing cues received during a theater performance, the wearable device comprising:
at least one hardware processor;
at least one non-transitory, computer-readable storage medium;
a haptic motor;
at least two communication interfaces,
wherein the wearable device is configured to receive, over at least a first communication interface of the at least two communication interfaces, a configuration associating the wearable device with a category of tasks related to the theater performance,
wherein the wearable device is configured to alert a user of the wearable device about cues belonging to the category of tasks that the wearable device is associated with,
wherein the wearable device is configured to receive the cues over the first communication interface of the at least two communication interfaces, and
wherein the wearable device is configured to determine a current location of the wearable device in relation to at least one location anchor disposed in the theater based on communication over a second communication interface of the at least two communication interfaces; and
at least one non-transitory memory storing instructions, which, when executed by the at least one hardware processor, cause the wearable device to:
determine a current location of the wearable device in relation to the at least one location anchor disposed in the theater;
compare the current location of the wearable device with a desired location of the wearable device; and
in response to determining that the current location of the wearable device is within a threshold distance from the desired location, alert the user at least by generating, from the haptic motor, a vibration signal.

2. The wearable device of claim 1, further caused to:
receive a configuration associating the wearable device with a first category of tasks related to the theater performance;
receive a first cue associated with a first task related to the theater performance,
wherein the first cue is further associated with a first identifier;
determine whether the first cue belongs to the first category of tasks; and
in response to determining that the first cue belongs to the first category of tasks, alert the user about the first cue.

3. The wearable device of claim 2,
wherein alerting the user about the first cue further comprises at least generating, from the haptic motor, a first vibration signal associated with the first cue.

4. The wearable device of claim 2, further comprising a screen,
wherein alerting the user about the first cue comprises displaying the first cue, the first identifier, or a text string associated with the first cue on the screen.

5. The wearable device of claim 2, further caused to:
receive a second cue associated with a second task related to the theater performance,
wherein the second cue is further associated with a second identifier;
determine whether the second cue belongs to the first category of tasks related to the theater performance;
in response to determining that the second cue does not belong to the first category of tasks, prevent alerting the user about the second cue.

6. The wearable device of claim 2, further caused to:
receive a third cue associated with a third task related to the theater performance, wherein the third cue is further associated with a third identifier;
determine whether the third cue belongs to the first category of tasks related to the theater performance;
in response to determining that the third cue belongs to the first category of tasks, alert the user about the third cue.

7. The wearable device of claim 6,
wherein alerting the user about the third cue further comprises generating, from the haptic motor, a second vibration signal associated with the third cue.

8. The wearable device of claim 1,
wherein the first communication interface is a wireless communication interface configured to operate in compliance with long-range wide area network (LoRaWAN) communication protocols.

9. The wearable device of claim 1,
wherein the second communication interface is a wireless communication interface configured to operate in compliance with ultra-wideband (UWB) communication protocols.

10. A method for processing cues received by a wearable device during a theater performance, the wearable device including a haptic motor and at least two communication interfaces, the method comprising:
receiving, by the wearable device, over at least a first communication interface of the at least two communication interfaces, a configuration associating the wearable device with a category of tasks related to the theater performance,
wherein the wearable device is configured to alert a user of the wearable device about cues belonging to the category of tasks that the wearable device is associated with, and
wherein the wearable device is configured to receive the cues over the first communication interface of the at least two communication interfaces;
determining, by the wearable device, a current location of the wearable device in relation to at least one location anchor disposed in the theater based on communication over a second communication interface of the at least two communication interfaces;
comparing, by the wearable device, the current location of the wearable device with a desired location of the wearable device; and
in response to determining that the current location of the wearable device is within a threshold distance from the desired location, alerting the user at least by generating, from the haptic motor, a vibration signal.

11. The method of claim 10, further comprising:
receiving a configuration associating the wearable device with a first category of tasks related to the theater performance;
receiving a first cue associated with a first task related to the theater performance,
wherein the first cue is further associated with a first identifier;
determining whether the first cue belongs to the first category of tasks; and
in response to determining that the first cue belongs to the first category of tasks, alerting the user about the first cue.

12. The method of claim 11,
wherein alerting the user about the first cue further comprises at least generating, from the haptic motor, a first vibration signal associated with the first cue.

13. The method of claim 11,
wherein alerting the user about the first cue further comprises displaying the first cue, the first identifier, or a text string associated with the first cue on a screen of the wearable device.

14. The method of claim 11, further comprising:
receiving a second cue associated with a second task related to the theater performance,
wherein the second cue is further associated with a second identifier;
determining whether the second cue belongs to the first category of tasks related to the theater performance; and
in response to determining that the second cue does not belong to the first category of tasks, preventing alerting the user about the second cue.

15. The method of claim 11, further comprising:
receiving a third cue associated with a third task related to the theater performance,
wherein the third cue is further associated with a third identifier;
determining whether the third cue belongs to the first category of tasks related to the theater performance; and
in response to determining that the third cue belongs to the first category of tasks, alerting the user about the third cue.

16. The method of claim 15,
wherein alerting the user about the third cue further comprises generating, from the haptic motor, a second vibration signal associated with the third cue.

17. The method of claim 10,
wherein the first communication interface is a wireless communication interface configured to operate in compliance with long-range wide area network (LoRaWAN) communication protocols.

18. The method of claim 10,
wherein the second communication interface is a wireless communication interface configured to operate in compliance with ultra-wideband (UWB) communication protocols.

19. A method for processing cues received by a wearable device during a theater performance, the wearable device including a haptic motor and at least two communication interfaces, the method comprising:
receiving, by the wearable device, over at least a first communication interface of the at least two communication interfaces, a configuration associating the wearable device with a category of tasks related to the theater performance,
wherein the wearable device is configured to alert a user of the wearable device about cues belonging to the category of tasks that the wearable device is associated with, and
wherein the wearable device is configured to receive the cues over the first communication interface of the at least two communication interfaces;
determining, by the wearable device, a current location of the wearable device in relation to at least one location anchor disposed in the theater based on communication over a second communication interface of the at least two communication interfaces;
comparing, by the wearable device, the current location of the wearable device with at least a first location and a second location of the wearable device; and
in response to determining that the current location of the wearable device is within a threshold distance from the first location, alerting the user at least by generating, from the haptic motor, a first vibration signal, or
in response to determining that the current location of the wearable device is within the threshold distance from the second location, alerting the user at least by generating, from the haptic motor, a second vibration signal.

20. The method of claim 19, further comprising:
receiving a configuration associating the wearable device with a first category of tasks related to the theater performance;
receiving a first cue associated with a first task related to the theater performance,
wherein the first cue is further associated with a first identifier;
determining whether the first cue belongs to the first category of tasks; and
in response to determining that the first cue belongs to the first category of tasks, alerting the user about the first cue at least by generating, from the haptic motor, a third vibration signal.
